(19) United States
(12) Patent Application Publication
(10) Pub. No.: US 2012/0087446 A1
(43) Pub. Date: Apr. 12, 2012

(54) Systems and methods for sparse error removal in communications systems

(75) Inventors: Renfei Liu, Irvine, CA (US); Keshab K. Parhi, Maple Grove, MN (US)

(73) Assignee: Leanics Corporation

(21) Appl. No.: 13/200,950

(22) Filed: Oct. 5, 2011

Related U.S. Application Data
(60) Provisional application No. 61/404,603, filed on Oct. 6, 2010.

(51) Int. Cl. H04L 27/06

(52) U.S. Cl. 375/340

(57) ABSTRACT

A method for robust demodulation of the communications system in presence of sparse severe impulse noise is presented. In this invention, the application of impulse noise removal in orthogonal frequency domain multiplexing systems is investigated. The impulse noise causes catastrophic accuracy degradation at the output of the fast Fourier transform operations at the receiver. In this invention, an impulse noise identification scheme is proposed to determine the presence of the impulse noise. An impulse noise value search algorithm at known location based on the steepest descent method, an impulse noise location algorithm, and a novel iterative impulse error correction scheme are presented to remove the sparse error and demodulate the transmitted symbols accurately.

### CROSS-REFERENCE TO RELATED APPLICATIONS

This application claims the benefit of U.S. Provisional Application No. 61/404,603, filed on Oct. 6, 2010, the entire content of which is incorporated herein by reference in its entirety.

### STATEMENT REGARDING FEDERALLY-SPONSORED RESEARCH AND DEVELOPMENT

This invention was made with Government support from the National Science Foundation (NSF) under Grant No. CCF-0811456.

### FIELD OF THE INVENTION

The present invention relates to sparse error correction, optimization, and data processing in digital communications systems including wired and wireless communication. More specifically, it is related to robust demodulation algorithm design to remove the impulse noise in the communications systems, such as the orthogonal frequency division multiplexing (OFDM) systems, where the transform of a symbol is transmitted.

### BACKGROUND OF THE INVENTION

Additive white Gaussian noise (AWGN) is the most common type of noise in various wired and wireless communication channels. Contrary to low noise power in AWGN, impulse noise severely corrupts data. The causes of impulse noise include circuit failure, power switching, erasure channel, etc. In OFDM systems, impulse noise turns out to be much more catastrophic than the AWGN due to the fast Fourier transform (FFT) operation at the receiver, which spreads the impulse noise and thereby severely corrupts the entire symbol. Assume sₜ is the time-domain sequence at the transmitter and vₖ is a single impulse noise at position k added to sₜ. Then the FFT of sₜ with the single impulse noise is given by:

s_{f}_{ᵢ}=Σⱼ₌₀^{N-1}W_{N}^{ij}sₜ_{ⱼ}+W_{N}^{ik}vₖ,

where i is an integer ranging from 0 to N−1, and W_{N}=e^{-j2π/N}. The error correction of impulse noise in OFDM systems is of great interest.

In modern digital communication, the FEC plays an important role in ensuring the quality and the reliability of the communication. Various complicated error coding and decoding algorithms and architectures have been proposed in the past 20 years. Some of the most widely used error correction codes include BCH code, Reed-Solomon code (RS-code), Hamming code, Turbo code, etc. The fundamental principle of these FECs is based on deliberately introducing redundancies or extra parity symbols from the information to be transmitted. These additional symbols along with the original information are transmitted through a noisy channel, which compromises the symbol accuracy. The receiver establishes the soft information, i.e., confidence level, for the received information, and makes decisions based on the ML and/or MAP criteria. The redundancy is essentially a set of linear equations. The performance of an FEC code is determined by the elaborate choice of the linear equations and the decoder design. Another method of recovering information in presence of noise involves exploiting the inherent properties of the signal itself.

In the past the problem of OFDM transmission corrupted by impulsive noise has been studied in the power-line application, where the impulsive noise is assumed to be the widely used Middleton's Class A man-made noise model that statistically describes the impulsive interference. This Class A noise probability density function (pdf) is given by

$${P}_{n} ( η ) = {e}^{- A} {\sum }_{m = 0}^{∞} \frac{{A}^{m}}{m ! 2 {πσ}_{m}^{2}} {e}^{- \frac{η * η}{2 {σ}_{m}^{2}}} ,$$

where σₘ²=(m/A+T)/(1+T). The parameter A is called the impulsive index that is the product of the average number of impulses per unit time and the mean duration of the emitted impulses entering the receiver. For A→∞ the noise becomes Gaussian distributed; for small A the noise becomes more structured and impulsive. The parameter T represents the ratio between the mean power of the Gaussian and the mean power of the impulsive noise component. For instance, when A=0.1 and T=10⁻³, about 10% of the samples are hit by impulsive noise and the average impulsive noise power is 1000 times that of Gaussian noise. (See D. Middleton: “Canonical and Quasi-Canonical Probability Models of Class A Interference,” IEEE Trans. Electromagnetic Compatibility, vol. EMC-25, no. 2, May 1983.)

Based on this impulsive noise model, an iterative approach has been proposed for removing impulsive noise in OFDM transmission. (See J. Haring and A. J. Han Vinck, “OFDM transmission corrupted by impulsive noise”, Proc. Int. Symp. Powerline Communications (ISPLC), pp. 9-14, 2000.) A noise threshold is derived based on the pdf of impulsive noise. Any time-domain signal sample that is larger than this threshold will be declared as corrupted by an impulsive noise and will be cleared to zero. It is assumed that this will bring the signal closer to its real value, and the demodulation is more likely to be correct. Later on, a more sophisticated iterative algorithm that further explores the pdf of the noise was proposed. This algorithm is also based on the assumption that the density of the impulsive noise magnitude imposed by the specific noise model is known. (See J. Haring and A. J. Han Vinck, “Iterative Decoding of Codes Over Complex Numbers for Impulsive Noise Channels,” IEEE Trans. on Info. Theory, vol. 49, no. 5, May 2003.)

In order to apply these two algorithms, the pdf of impulse noise is assumed to be known; however, it is not practical to obtain such information. What are needed for impulse noise removal over OFDM systems are 1) an algorithm to identify the existence of impulse noise, 2) an algorithm to find the location of impulse noise, and 3) an algorithm to remove the impulse noise with unknown amplitude. The present invention focuses on improving system performance using the FFT property to design algorithms for impulse noise removal in OFDM systems.

### BRIEF SUMMARY OF THE INVENTION

The present invention provides a new approach for removing impulsive noise in communications systems. In one embodiment, the symbol is transmitted using the inverse fast Fourier transform (IFFT) in OFDM systems. In another embodiment, the symbol is transmitted using the linear transform in communications systems. In this invention, the system performance is illustrated using the OFDM systems. We view the impulse noise as a different type of noise in terms of space and magnitude as opposed to the AWGN noise, and investigate its performance impairment upon the OFDM systems as well as the corresponding correction schemes. The present invention is different from previous works on impulse noise, which focus on the communication channel and mathematical modeling of the impulse noise characterization.

Novel techniques that exploit the nature of discrete Fourier transform (DFT) computation are proposed to serve as the basis of correcting impulse noise in OFDM systems. The proposed impulse noise location and value search algorithm is based on the crucial observation of the relationship of the impulse noise to the symbol constellation plot.

Further embodiments, features, and advantages of the present invention, along with structure and operation of various embodiments of the present invention, are discussed in detail below with reference to the accompanying figures.

### BRIEF DESCRIPTION OF THE DRAWINGS/FIGURES

The present invention is described with reference to the accompanying figures. In the figures, like reference numbers indicate identical or functionally similar elements. Additionally, the left-most digit or digits of a reference number identify the figure in which the reference number first appears. The accompanying figures, which are incorporated herein and form part of the specification, illustrate the present invention, and together with the description, further serve to explain the principles of the invention and to enable a person skilled in the relevant art to make and use the invention.

FIG. 1 illustrates an OFDM transceiver structure.

FIG. 2 illustrates the signal constellation after signal is transmitted over the noiseless and noisy channels.

FIG. 3 illustrates the impulse noise identification scheme.

FIG. 4 illustrates how to apply pseudo-SNR to identify the existence of impulse noise.

FIG. 5 illustrates cost function for various impulse noise values.

FIG. 6 illustrates the impulse noise value search algorithm at known locations and simulation results.

FIG. 7 illustrates the iterative impulse noise correction scheme.

FIG. 8 illustrates the iterative impulse noise location and value search algorithm.

FIG. 9 illustrates an iterative impulse noise correction scheme example.

FIG. 10 illustrates the performance of this invention.

### DETAILED DESCRIPTION OF THE INVENTION

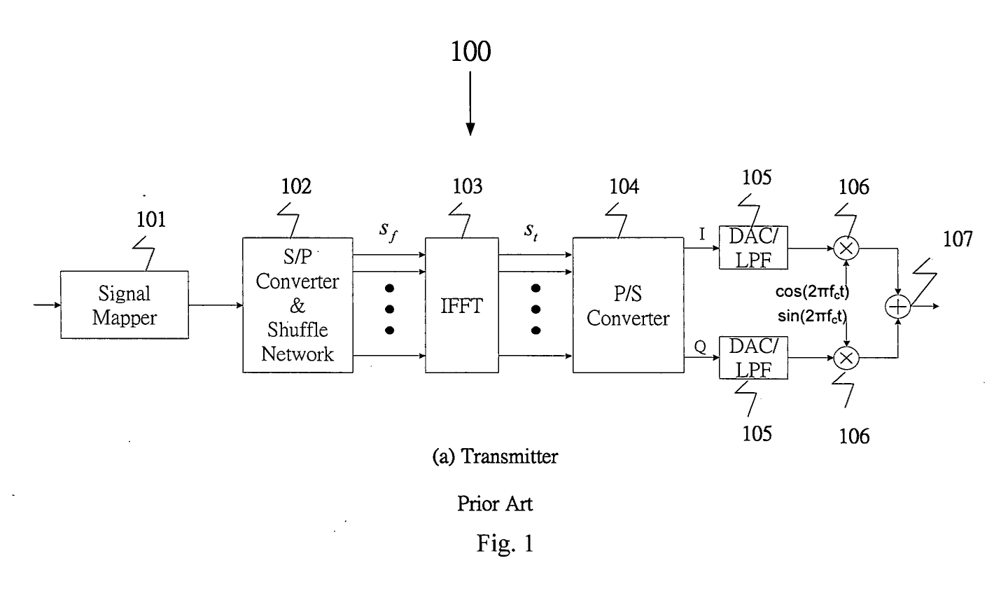

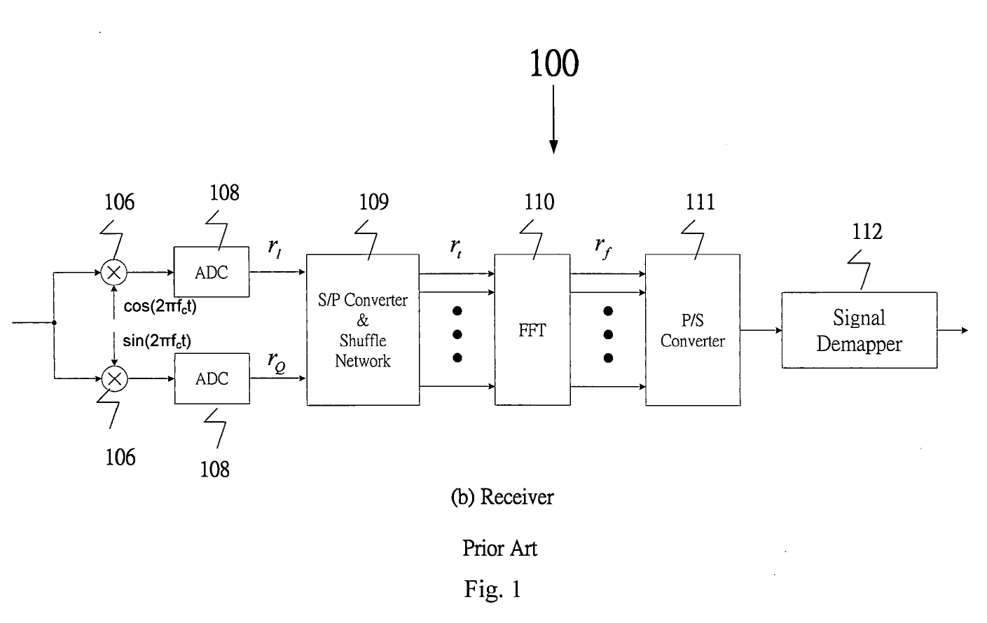

As a powerful modulation scheme that combats severe channel conditions without complex equalizers, OFDM has been broadly used in various wireless/wired communication systems. A typical baseband OFDM system at the transmitter and the receiver are shown in FIG. 1(a) and FIG. 1(b), respectively. System 100 consists of twelve blocks ranging from 101 to 112. At the transmitter, binary bits are mapped into symbols using block 101. In one embodiment, these symbols may represent quadrature amplitude modulation (QAM) symbols. In another embodiment, these symbols may represent binary phase shift keying (BPSK) symbols. Then, the obtained sequential symbols s_{f}={s_{f}_{₁}, s_{f}_{₂}, . . . , s_{f}_{_{N}}} are shuffled and converted into N parallel data using block 102 and fed into the block 103 which performs a N-point inverse FFT (IFFT) operation. The block 104 uses the real and imaginary parts of the IFFT output sequence sₜ to form I (in-phase) and Q (quadrature) signals, respectively. I and Q signals are carried on cosine and sine waves through block 106, and then block 107 adds these two signals to form the signal for transmission after they pass the block 105, which includes low-pass filters (LPF) and digital-to-analog converters (DAC). In presence of channel noise and various channel effects such as erasure and fading, the received time domain signal is a noisy version of the original signal. The receiver reverses operations at the transmitter. First, block 106 and block 108 separate r₁ and r_{Q} signals from the received signal, and then block 110 performs an FFT transform on the rebuilt noisy time-domain sequence rₜ to obtain a noisy symbol sequence r_{f}. The time-domain sequence rₜ=sₜ+v+n is a reshuffled version of r₁ and r_{Q}, signals using block 109, where sₜ is the transmitted signal, v is the impulse noise, and n is the AWGN noise. The block 111 transforms the noisy symbol sequence r_{f} to sequential symbols, and then r_{f} is demodulated by block 112 to reconstruct the original signal.

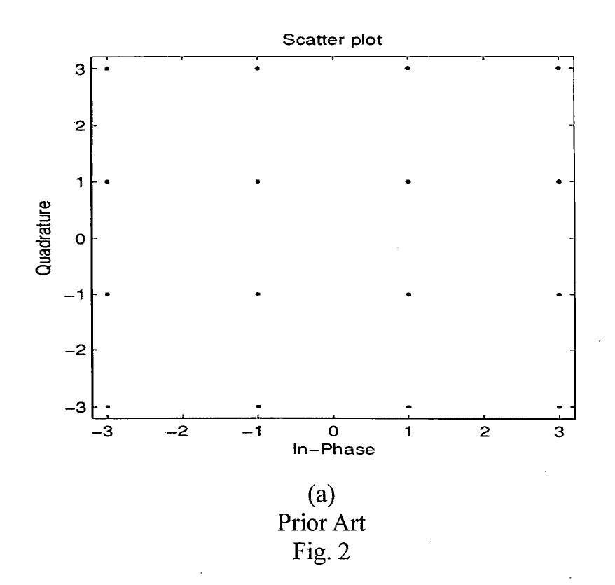

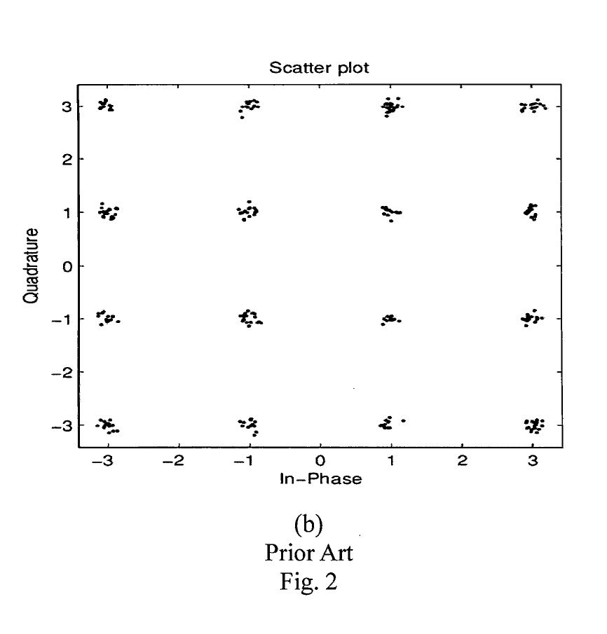

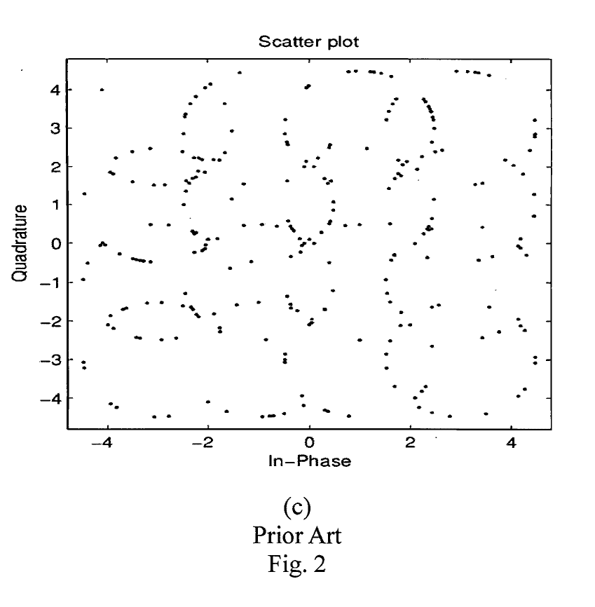

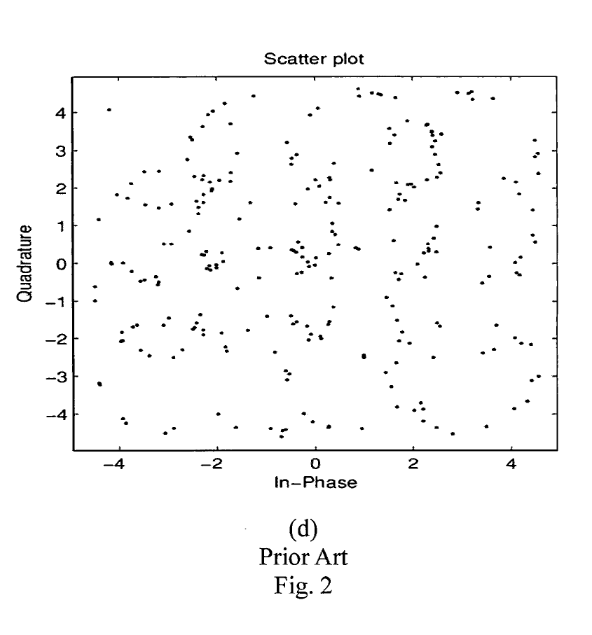

FIG. 2 shows simulation results of constellation plots of received signal for an example of OFDM systems with 512-point IFFT/FFT in presence of various noises. In FIG. 2(a), the signal constellation plot represents the case when the signal is transmitted over a noiseless channel. Due to their distinct features, the AWGN and the impulse noise manifest themselves distinctly at the output of the FFT unit at the receiver. As for the AWGN, the simulation of a 512-point FFT constellation plot shows that the output signals of the FFT are randomly scattered around the modulation symbols in FIG. 2(b). Thus, we simply map constellation points in FIG. 2(b), which are obtained in presence of noise with signal-to-noise ratio (SNR)=30 decibel (dB), to the closest symbols for restoring frequency-domain symbols. As for the impulse noise, the constellation plot exhibits a distinct view from that of AWGN. For instance, FIG. 2 (c) shows the FFT output of a time-domain sequence, which is corrupted by an error of magnitude 0.5 at a single position. It is seen that severe noise affects all output constellation points, albeit it occurs at a single sample in sₜ. Obviously the symbol mapping scheme fails because the “non-severeness” feature of the noise does not hold any more and the noisy symbols are scattered across the plane. Furthermore, due to the intensive erroneousness, we can hardly rely on error control coding for recovering the modulated symbols. When both AWGN and impulse noises are present at the time domain signal, the FFT outputs become even more difficult for demodulation in FIG. 2(d). As can be seen in the simulation described in FIG. 2, while the impulse noise scrambles constellation points away from their centers in circles with large radius, the AWGN tends to distribute these points closely around their centers. Therefore, by comparing FIG. 2(c) and FIG. 2(d), we can easily differentiate the AWGN from impulse noise intuitively based on the constellation scattering pattern. In other words, this scattering pattern can become a potential error correction criterion, as a novel alternative to the existing two major correction bases. Nevertheless, as the number of impulse noise combined with the AWGN increases, it becomes less obvious for one to identify the impulse noise. Hence, a quantitative identification algorithm is required. Although a graphical pattern recognition algorithm may serve our purpose in some sense, it also usually requires tremendous computational complexity and is not attractive for implementation. Thus, we propose a practical computationally-efficient algorithm for identifying impulse noise from the AWGN. This impulse noise identification algorithm, essentially, converts the pattern recognition to a problem in communication.

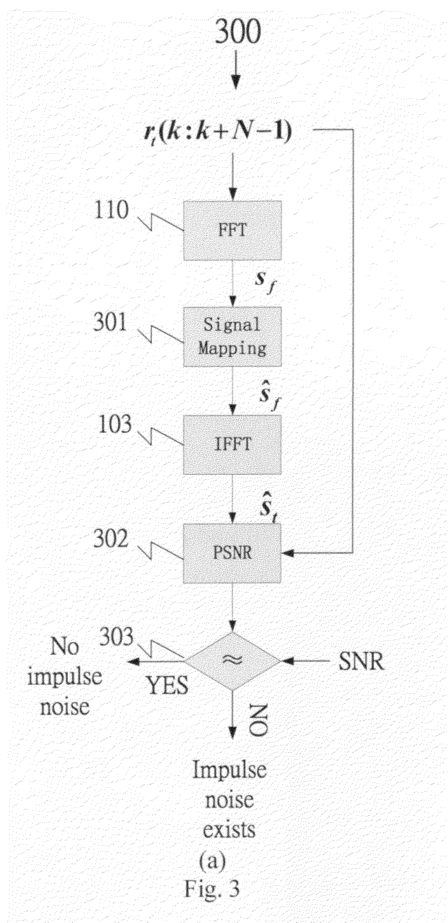

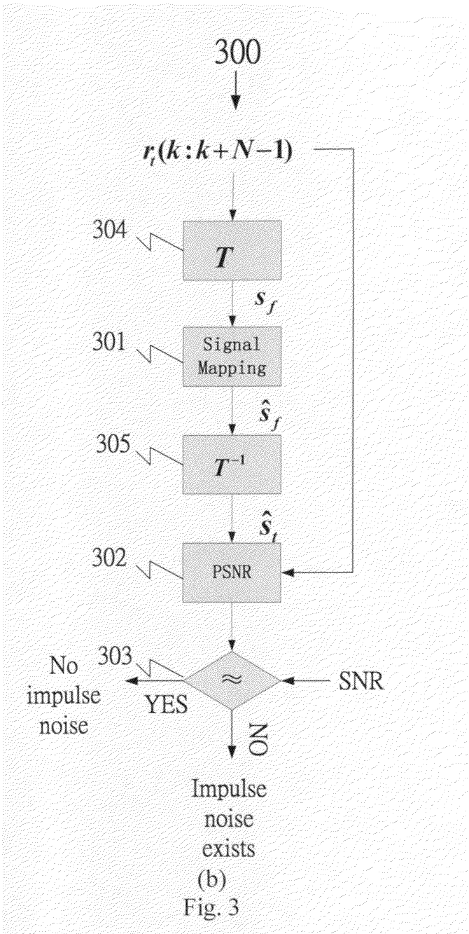

Assume that the prior knowledge of the modulation scheme and AWGN channel is known to the receiver. The impulse noise identification algorithm is described in FIG. 3. The impulse noise identification algorithm based on OFDM demodulators is presented in FIG. 3(a). In FIG. 3(a), for the first three blocks, which are block 110, block 301, and block 103, we attempt to re-produce the noiseless time-domain sequence via sequentially performing FFT, symbol mapping and IFFT. The function in block 301 is based on the simple minimal distance basis, and the set of discrete constellation symbols is the QAM symbol set adopted for modulation. Then, the existence of impulse noise can be determined by comparing the calculated SNR with the prior SNR knowledge using block 303. Such calculated SNR (=10 log₁₀(∥sₜ∥²/∥n∥²)) is referred to as pseudo-SNR (=10 log₁₀(∥ŝₜ∥²/∥n∥₂)) by block 302 because it is obtained by comparing the received signal rₜ with an estimated signal ŝₜ, instead of the noiseless signal sₜ. This algorithm is based on the fact that presence of the impulse noise causes significant degradation for signal recovery as opposed to the AWGN. It is worth noting that the pseudo-SNR should match the prior knowledge of the channel SNR, i.e., the difference between these two values should be less than a threshold, which is determined by how well the prior information about the channel SNR is known. The detailed description of the impulse noise identification algorithm is summarized in the Algorithm 1. In FIG. 3(b), we present a generalized impulse noise identification algorithm for any demodulators that does not operate in the time domain. Block 304 performs any transform function on the received signal, and block 305 performs the corresponding inverse transform function on the estimated signal.

Algorithm 1: Impulse Noise Identification

Function: Determine whether impulse noise exists in presence of AWGN
Inputs: 2N-point noisy time domain sequence rₜ and its SNR
Procedures:

| | |
|---|---|
| 1: | Obtain noisy symbols: s_{f} = FFT{rₜ} |
| 2: | Map s_{f} to a set of discrete constellation symbols: ŝ_{f} = Map(s_{f}) |
| 3: | Re-produce pseudo noiseless samples: ŝₜ = IFFT{ŝ_{f}} |
| 4: | Extract pseudo-SNR by comparing ŝₜ with rₜ. |
| 5: | if The pseudo-SNR matches the prior knowledge of SNR |
| | then |

| | |
|---|---|
| 6: | No impulse noise exists and return. |

| | |
|---|---|
| 7: | else |

| | |
|---|---|
| 8: | The impulse noise exists. |

| | |
|---|---|
| 9: | end if |

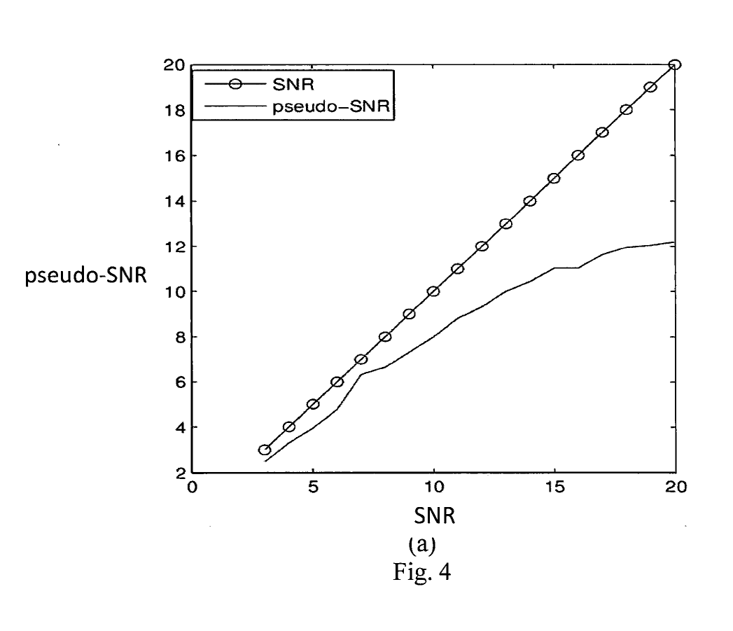

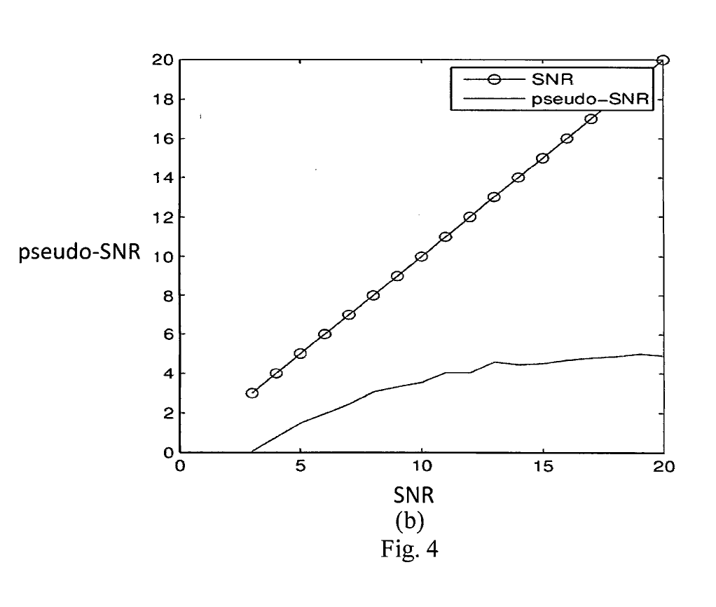

For the purpose of illustration, we simulate the pseudo-SNR in presence of various AWGN SNR values in FIG. 4(a). In the simulation, we assume that there exists a single impulse noise at a random position in a 512-point sₜ with QAM-16 modulation. The magnitude of the error is about twice the maximal value in sₜ. It is seen that the real SNR and pseudo-SNR start to diverge at about 8 dB, and the gap becomes larger for higher SNR values. As the number of impulse noise samples increases, the divergence point will move towards lower SNR as shown in FIG. 4(b), in which the impulse noise equally corrupts 20 signal samples. As can be seen in the proposed algorithm, the graphical scattering pattern resulting from the impulse noise is translated into the divergence between pseudo-SNR and AWGN SNR, which identifies the impulse noise from the AWGN. This simple algorithm demonstrates the effectiveness of the novel criterion in an identification algorithm. Based on this fact, we continue the development of a complete error correction scheme based on the same principle. The problems of determining error locations and values will be solved separately.

If we assume that the location of the impulse noise is known, an impulse error search algorithm is proposed. Contrary to widely used FEC codes where the errors are usually bits or symbols, the impulse noise to be removed is a real number, and hence, the problem of determining the noise value is not trivial. The impulse noise vector is denoted by v, consisting of zeros and impulse noise values at known positions. Thus, if an impulse noise of magnitude v₂ occurs at the second position in the time domain sequence, then the impulse noise vector v can be expressed in v=[0 v₂ 0 . . . 0]. The optimization is used to search for the impulse noise error values, our proposed algorithm is called impulse noise searching algorithm. We re-formulate the impulse noise removal problem as: Finding an error vector v so as to minimize the cost function as given in

J=∥(rₜ−v)−H⁻¹fᵣ_{ₜ}_{,v}[H(rₜ−v)]∥₂

v=arg minᵥJ(rₜ,v)

where H and H⁻¹ are FFT and IFFT transforms, respectively, and fᵣ_{ₜ}_{,v} is a non-linear mapping function of rₜ and v that map noisy symbols onto constellation points. The principle of Algorithm 1 leads to the formulation of J. When an error vector that is close to the actual impulse noise is found, the SNR of the recovered real-valued sequence H⁻¹fᵣ_{ₜ}_{,v}[H(rₜ−v)] matches our prior knowledge of AWGN. Otherwise, the presence of the impulse noise leads to severe SNR degradation. Therefore, in presence of AWGN noise, the minimal cost is equal to the variance of AWGN; in case of no AWGN, the cost function can be minimized to zero. J is directly derived from the preceding impulse noise identification algorithm; however, to reduce the computational complexity, it can be re-written as

J=∥H(rₜ−v)−fᵣ_{ₜ}_{,v}[(rₜ−v)]∥₂

where Hrₜ only needs to be calculated once, Hv is cost-efficient if the number of impulse errors is not large, and H(rₜ−v) can be calculated incrementally. Evidently the challenge of solving this optimization problem lies in the non-linear mapping function, which is dependent on both rₜ and v. Such a multi-dimensional dependency dramatically complicates the optimization, and thereby leads to unacceptable computational complexity. Our strategy is to bypass the analysis of fᵣ_{ₜ}_{,v} and to study the relationship between the impulse noise vector v and the cost J, dropping the factor rₜ.

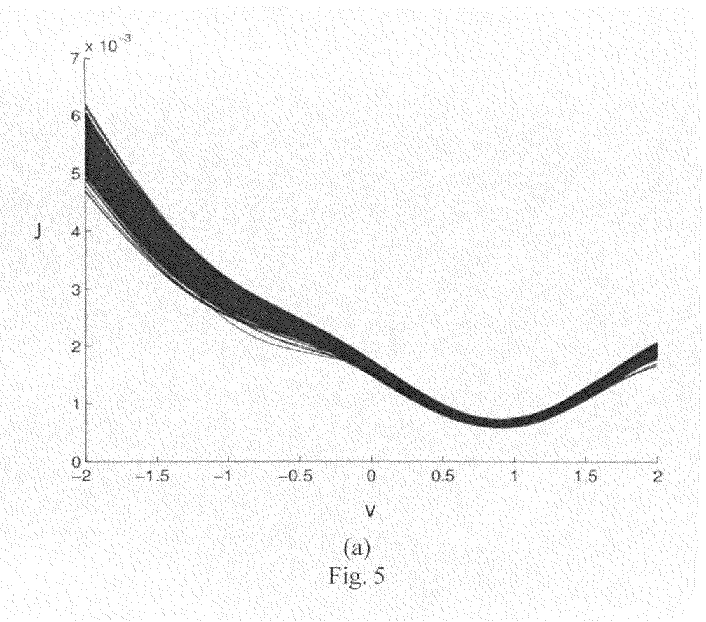

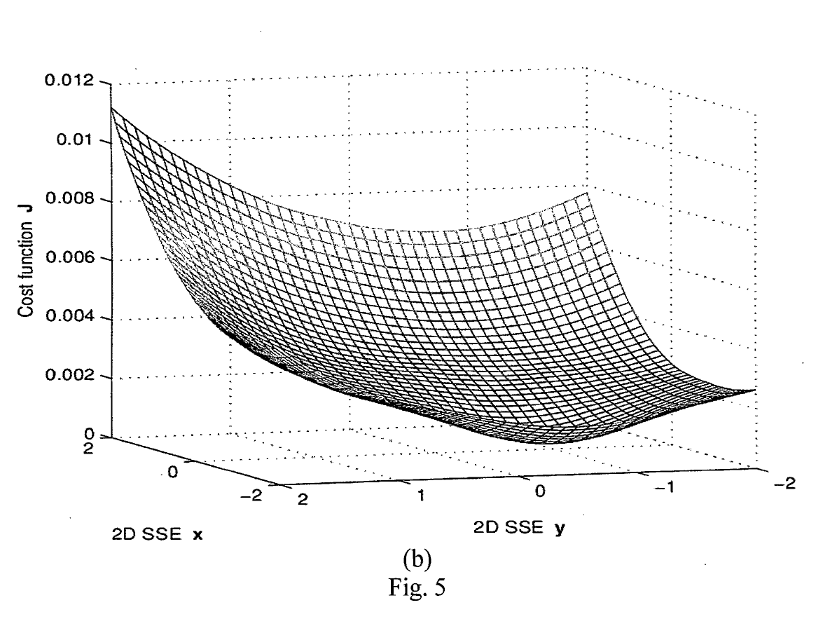

When it comes to higher modulation schemes, it is uncertain whether the position of the impulse noise will affect the relationship pattern between the error value and the cost function. To answer this question, we simulate the cost function versus the error value with the error position varying from 1 to 512 with the assumption of 512-point FFT QAM-16. The resulting relationship is accumulated as shown in FIG. 5(a) where the error value is assumed to be 0.9. This simulation concludes that the impulse noise position plays a trivial role in determining the relationship function; however, it re-confirms that there are cases where there exists a global minimum. It is observed that the AWGN eliminates local minimums that are near the global minimum. This leads to the convex-like function and thereby enables computationally-efficient optimization. This is because the presence of AWGN dramatically scrambles the distribution pattern resulting from the impulse noise. In addition, FIG. 5(b) plots the cost function with respect to two impulse noises for QAM-16 in presence of 15 dB AWGN. It is seen that AWGN plays a critical role in this invention.

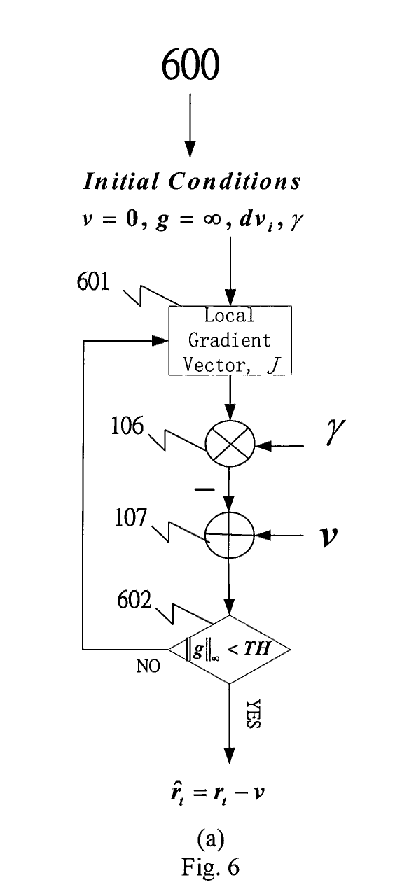

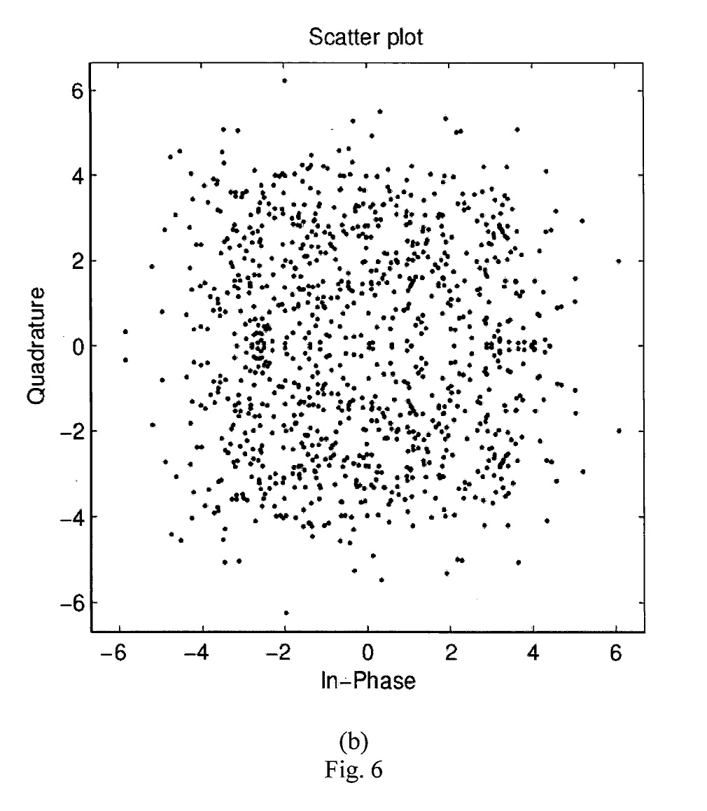

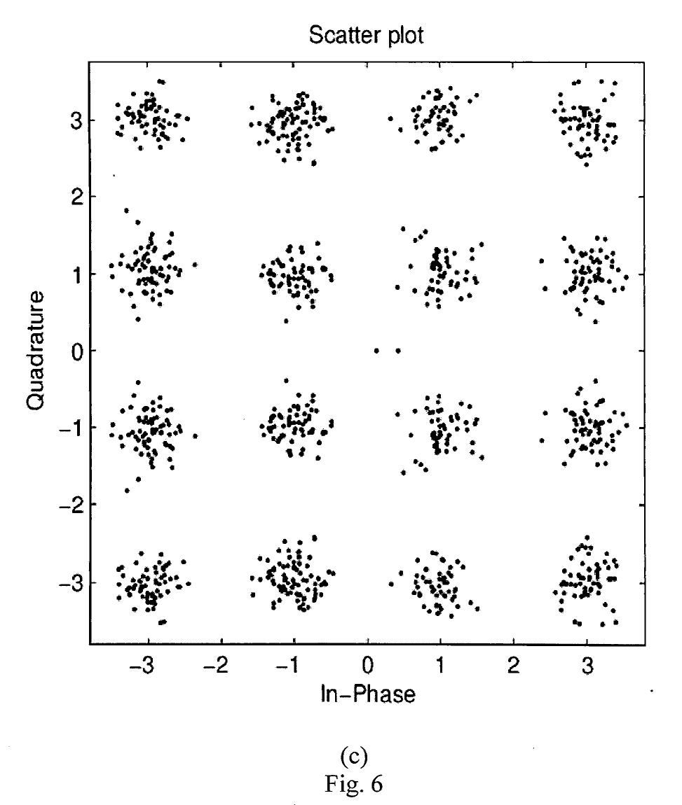

We use the steepest descent algorithm as shown in FIG. 6(a) to solve the error vector just for the purpose of illustration. In FIG. 6(a), rₜ is the received signal, TH is a small threshold value, g is the local gradient vector, ∥g∥ is the vector norm, dvᵢ is a step vector containing a single non-zero delta at the ith position, used for computing the local gradient in the ith dimension, γ is a constant step used for moving towards the minimum, block 601 computes gᵢ=(J(v+dvᵢ)−J(v))/dvᵢ for each position, and v is the estimated impulse noise vector. We estimate the impulse noise vector in an iterative manner until ∥g∥_{∞} is less than TH. Once the error vector is determined, it is removed from the noisy samples. The detailed description of the Impulse Noise Value Search Algorithm at known locations is summarized in the Algorithm 2. To show the effectiveness of our proposed error value search algorithm, we present an example in the configuration of 1024-point FFT with QAM-16 and the maximal sample value in sₜ is 0.31. Assume that there are 20 sparse severe errors which have Gaussian distribution N(0.2, 0.1) and AWGN is of SNR=20 dB. Then, constellation of the FFT(rₜ) is shown in FIG. 6(b); obviously noisy symbols seem to be randomly scattered in the plane and cannot be correctly demodulated. On the contrary, FFT of the recovered fₜ obtained by module 600 and presented in FIG. 6(c) gives a much clearer view, which significantly facilitates further error control decoding and demodulation.

Algorithm 2: Impulse Noise Value Search
Algorithm at Known Locations

| Function: Searching for the impulse noise | |
|---|---|
| values when their locations are known | |
| Inputs: 2N-point noisy time domain sequence rₜ and its SNR | |
| Procedures: | |
| 1: | Initialize: v=0, g = ∞, dvᵢ, γ |
| 2: | while ∥g∥_{∞} < TH |

| | |
|---|---|
| 3: | Compute local gradient vector |
| 4: | for all gᵢ in g do |

| | |
|---|---|
| 5: | gᵢ = (J(v + dvᵢ) − J(v))/dvᵢ |

| | |
|---|---|
| 6: | end for |
| 7: | v = v − γ × g |

| | |
|---|---|
| 8: | end while |
| 9: | \hat{r}ₜ = rₜ − v |

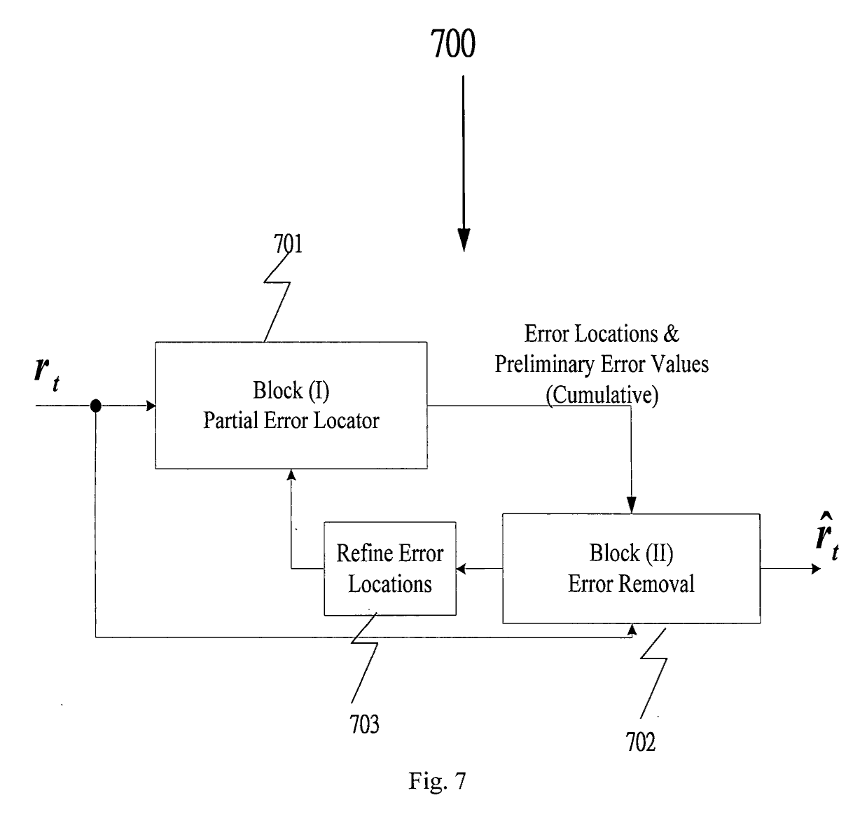

An iterative impulse error correction scheme without knowing the impulse noise locations is proposed in FIG. 7 and described in Algorithm 3. This iterative algorithm consists of two major blocks, which are the block 701 and block 702. Block 701 tentatively determines a subset of the impulse noise locations, and it is not required to guarantee that the determined locations are all correct; misdetection is allowed. Meanwhile, it also optionally determines the preliminary impulse noise value at these locations. Block 702 takes these tentative error locations and the optional preliminary guessed values as the known information and searches for the corresponding impulse noise values. Although block 701 does not guarantee that the tentative impulse noise locations are correct, block 702, which is responsible for searching for the error values, will not be affected by this wrong location. This is because block 702 refines the location information and aids block 701 in the next iteration. The optional preliminary noise value is to help block 702 to converge fast with a good initial guess if an optimization algorithm is used. Through iterations, block 701 and block 702 exchange impulse noise location and value information until all impulse noises are eliminated. It is seen that block 702 eliminates partial impulse noise based on the partial locations information in each iteration, and the accuracy level of the location and impulse noise value are accumulated through the mutual information exchange through iteration. Note that block 702 refines the error location information based the error magnitude; a reasonable value for this threshold is two times the maximal signal magnitude, which defines the impulse noise. Then, block 703 will send the updated error location to block 701.

Algorithm 3: Iterative Impulse Noise Correction Scheme

Function: Detect and correct impulse noise in an OFDM system
Procedures:

| | |
|---|---|
| 1: | while The pseudo-SNR is not equal to the known AWGN SNR do |

| | |
|---|---|
| 2: | In each iteration: |
| 3: | Block 701: |
| 4: | Based on the noisy signal, the impulse noise locations |

are tentatively determined

| | |
|---|---|
| 5: | Based on the noisy signal, determine the preliminary |
| | impulse |

noise value at these locations (Optional)

| | |
|---|---|
| 6: | Pass these tentative locations and/or values to Block 702 |
| 7: | Block 702: |
| 8: | Determine impulse noise values at these tentative |
| | locations |
| 9: | for Each calculated impulse noise value at a tentative |

location do

| | |
|---|---|
| 10: | if The calculated noise value is less than the |
| | threshold that |

defines a impulse noise then

| | |
|---|---|
| 11: | This position is determined as an invalid |
| | impulse noise error |

| | |
|---|---|
| 12: | end if |

| | |
|---|---|
| 13: | end for |
| 14: | Remove the valid impulse noise from the noisy signal |
| 15: | Return the improved signal and refined impulse noise |
| | locations |

to Block 701 so that they are excluded for determining
error locations
in the next iteration

| | |
|---|---|
| 16: | end while |

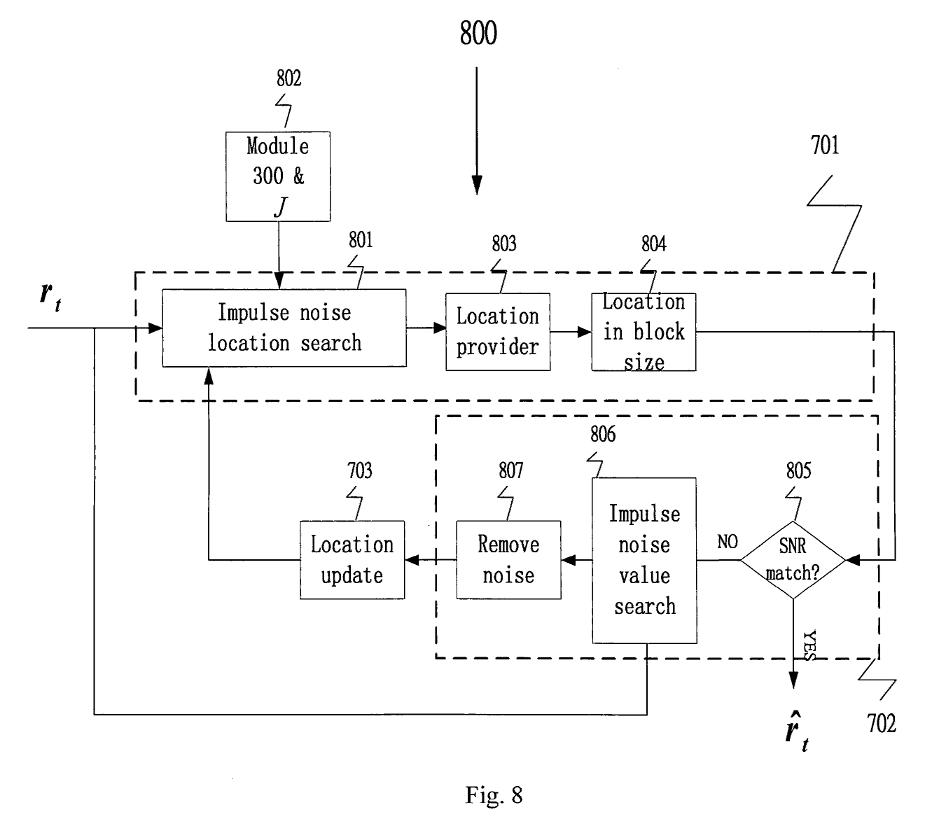

Based on the proposed impulse noise value search algorithm, a concrete iterative scheme, referred to as the iterative impulse noise location and value search scheme, is implemented in Algorithm 4 and Algorithm 5. FIG. 8 shows the overall system where the block diagrams of Algorithm 4 and Algorithm 5 have been incorporated to implement Algorithm 3. The block 701 consists of four blocks, which are block 801, block 802, block 803, and block 804. Block 801 searches some possible locations that the impulse noise exists with the help of block 802. Once the block 801 obtains the possible locations and/or possible impulse noise values, these results are stored in block 803, and are provided to block 804. The block 702 consists of block 805, block 806, and block 807. Block 805 compares the recovered SNR with the real SNR, if the recovered SNR matches the real SNR, then the impulse noise errors are eliminated from the received signal. On the other hand, if the recovered SNR does not match the AWGN SNR, block 806 searches the impulse noise values by Algorithm 2. Once block 806 obtains the impulse noise values, block 807 removes the impulse noise errors based on the results from block 806. Then, block 703 updates the error location, and sends the information to block 801. This iterative error correction scheme ends until the recovered SNR matches the AWGN SNR.

Algorithm 4: Impulse noise location Algorithm

Function: Tentatively determine a subset of the impulse noise locations
Procedures:

| | |
|---|---|
| 1: | for Each location that is not notified by block 702 |
| | to be excluded do |

| | |
|---|---|
| 2: | Assume this sample is corrupted by an impulse noise |
| 3: | Search for the impulse noise value that maximizes the |

pseudo-SNR based on module 300 and optimization algorithm J

| | |
|---|---|
| 4: | Record this maximal pseudo-SNR and the noise values that |
| | can |

achieve this pseudo-SNR

| | |
|---|---|
| 5: | end for |
| 6: | Choose a set of locations that provide the largest pseudo-SNR based |
| | on either of the two criteria |
| 7: | Choose the set of fixed block size |
| 8: | Return the chosen set of locations and their corresponding noise |
| | values |

Algorithm 5: Impulse Noise Value Search Algorithm

Function: Search for the impulse noise value
at the tentative impulse noise positions
Procedures:

| | |
|---|---|
| 1: | Apply module 600 to determine the impulse noise value |
| 2: | if The recovered SNR matches AWGN SNR then |

| | |
|---|---|
| 3: | The iteration stops and return the impulse-noise-free |
| | signal |

| | |
|---|---|
| 4: | else |

| | |
|---|---|
| 5: | Positions are determined as valid impulse noise locations |

if their noise values are not trivial and are thereby
identified
as impulse noise

| | |
|---|---|
| 6: | Return these valid impulse noise locations so that they |
| | will |

be excluded in the block 701 processing in the next iteration

| | |
|---|---|
| 7: | Return the improved signal whose impulse noise is partially |
| | removed |

| | |
|---|---|
| 8: | end if |

The block size in block 804 determines the trade-offs of the iterative algorithm. If the size is too small, it takes more iterations to accomplish the impulse noise correction. On the other hand, if the size is too large, the computational complexity in block 702 increases dramatically due to the increased number of error vector non-zero elements. The key to fast convergence lies in that block 701 always passes valid initial values to block 702. Note that the recovered SNR should match the AWGN SNR if all impulse noises are successfully removed. Since the presence of an uncorrectable impulse noise would lead to large discrepancy between the SNR and pseudo-SNR, a threshold that is smaller than this unacceptable large discrepancy can be used as the stopping criteria. This stopping criteria is also determined by the later FEC decoding capability.

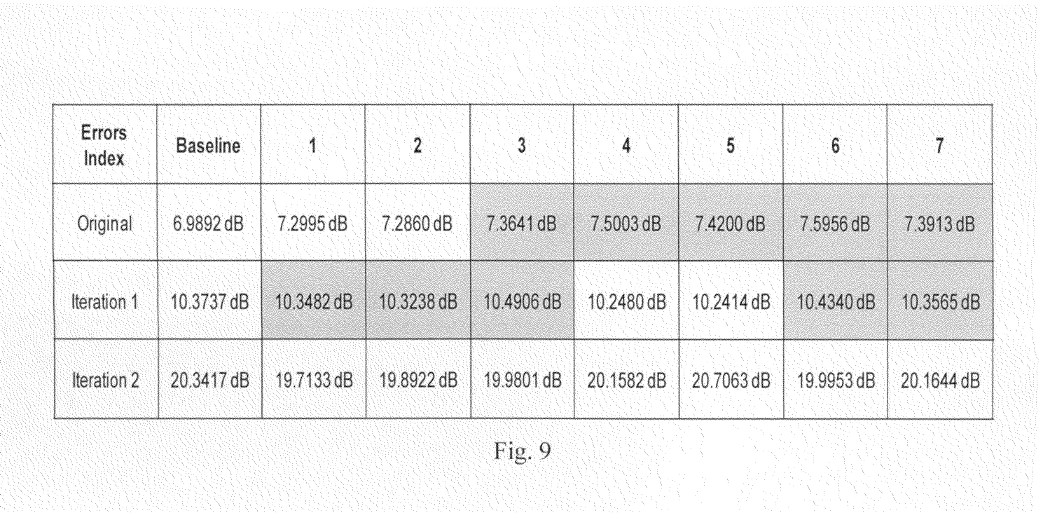

Now, we use a concrete example to show the detailed iterations of the complete iterative impulse error correction scheme as summarized in FIG. 9, where the pseudo-SNRs for each of the 7 erroneous positions in block 701 are listed in rows. Assume that the AWGN SNR is 20 dB, and 7 impulse errors present in the time-domain signal. In each iteration, block 701 selects 5 locations that achieve the largest pseudo-SNR. Impulse errors at positions 3-7 are found in the first iteration, and errors at positions 1-3 and 6-7 are found in the second iteration. We can see that the pseudo-SNR is improved over iterations, and only 2 iterations are needed for block 701 and block 702 to accomplish the impulse error correction.

We present simulation results of the proposed impulse noise correction scheme based on the iterative error locating and value search scheme. We assume a 512-point OFDM system with QAM-4 and/or QAM-8 modulation. In the simulation, the noiseless time-domain signal is transmitted through an AWGN channel at 25 dB SNR in combination with impulse noises, whose magnitude varies from 0.5-1.5 of the maximum magnitude of the noiseless time-domain signal. Also, we choose 0.1 dB as the stopping criteria threshold for our proposed algorithm; in other words, the algorithms stop when the recovered pseudo-SNR is 0.1 dB less than the prior known channel SNR. The AWGN SNR is constant through various simulations, and the location of the impulse noise is randomly selected. This is because it has been pointed out that our proposed impulse noise correction algorithms are invariant to the AWGN SNR and the impulse noise locations. When the modulation scheme is QAM-4, a typical maximum 25 dB AWGN noise magnitude is 0.0103 while the maximal signal magnitude is 0.2138. It is seen that the noise is rather small compared to the signal in magnitude. However, in presence of 5 impulse errors, whose maximum magnitude is 0.2846, the channel SNR is degraded from 25 dB down to 11.7 dB. Again, this shows that our proposed scheme can combat impulse noise.

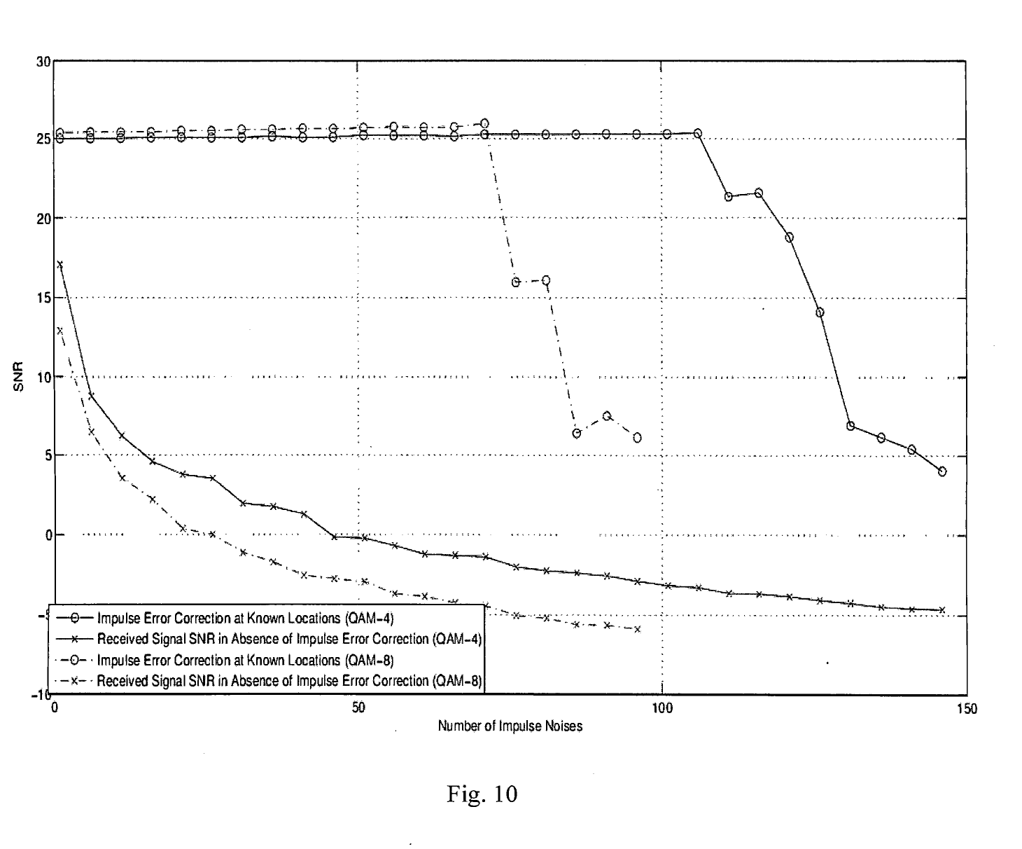

As the block 702 unit plays a critical role in determining the overall impulse noise correction capability as seen in FIG. 7, its performance is first investigated. As used in the block 702 unit, the error searching algorithm at known locations is evaluated and its performance against various number of impulse noises is plotted in FIG. 10. The results show that the impulse noise dramatically degrades the channel SNR for both QAM-4 and QAM-8 modulations. For QAM-4 modulation, the proposed error searching algorithm can correct up to 120 impulse noises, while for QAM-8 modulation it can correct up to 70 impulse noises.

It will be understood by those skilled in the relevant art that various changes in form and details of the embodiments described may be made without departing from the spirit and scope of the present invention as defined in the claims. Thus, the breadth and scope of present invention should not be limited by any of the above-described exemplary embodiments, but should be defined only in accordance with the following claims and their equivalents.

What is claimed is:

1. A sparse severe noise detector for determining presence of sparse severe noise in a communications receiver by computing a transform of the received signal, mapping it to a signal mapper and then taking an inverse transform of the mapped signal, and then comparing the signal to noise ratio of this transformed mapped signal with a reference signal to noise ratio, and comparing this difference with a threshold.

2. The communications receiver in claim 1 where the transform used is a Fourier transform.

3. The communications receiver in claim 1 where the transform used is a linear transform.

4. The communications receiver in claim 1 where the receiver makes use of an orthogonal frequency division multiplexing system.

5. A communications receiver to demodulate and decode a received signal in presence of sparse severe noise, comprising:
i. A sparse severe noise detector;
ii. An iterative detection, refinement and removal of a sparse error location from the received signal;
iii. Improving the received signal by subtracting the sparse severe error detected in step (ii) from the current signal;
iv. Repeat steps (ii) and (iii) until the signal to noise ratio of the improved signal in step (iii) is close to a reference signal to noise ratio within a specified a threshold value.

6. The communications receiver in claim 5 used in an orthogonal frequency division multiplexing (OFDM) system.

7. The communications receiver in claim 5 used in a wired communications application.

8. The communications transceiver in claim 5 used in a wireless communication application.

9. The communications transceiver in claim 5 used in a telemetry application.

10. An integrated circuit implementing a communications receiver to demodulate and decode a received signal in presence of sparse severe noise, comprising:
i. A sparse severe noise detector;
ii. An iterative detection, refinement and removal of a sparse error location from the received signal;
iii. Improving the received signal by subtracting the sparse severe error detected in step (ii) from the current signal;
iv. Repeat steps (ii) and (iii) until the signal to noise ratio of the improved signal in step (iii) is close to a reference signal to noise ratio within a specified a threshold value.

11. The communications receiver in claim 10 used in an orthogonal frequency division multiplexing (OFDM) system.

12. The communications receiver in claim 10 used in a wired communications application.

13. The communications transceiver in claim 10 used in a wireless communication application.

14. The communications transceiver in claim 10 used in a telemetry application.
